(19) United States
(12) Patent Application Publication
(10) Pub. No.: US 2025/0359500 A1
(43) Pub. Date: Nov. 27, 2025

(54) SYSTEM AND METHOD FOR PLANNING AN AGRICULTURAL WORK

(71) Applicant: CLAAS Selbstfahrende Erntemaschinen GmbH, Harsewinkel (DE)

(72) Inventors: Thijs Verploegen, Düsseldorf (DE); Stefan Peters, Münster (DE); Josef Fischer, Biberach (DE); Jan Carsten Wieckhorst, Uelzen (DE); Jannik Redenius, Oldendorf (DE); Axel Schröder, Gütersloh (DE); Felix Hülsmann, Bielefeld (DE); Robin Monkenbusch, Rheda-Wiedenbrück (DE)

(73) Assignee: CLAAS Selbstfahrende Erntemaschinen GmbH, Harsewinkel (DE)

(21) Appl. No.: 19/219,018

(22) Filed: May 27, 2025

(30) Foreign Application Priority Data
May 27, 2024 (DE) 10 2024 114 798.9

(51) Int. Cl. A01B 79/00; G05D 1/224; G05D 1/648; G05D 1/698; G05D 105/15; G05D 107/20

(52) U.S. Cl. CPC A01B 79/005; G05D 1/2245; G05D 1/648; G05D 1/6987; G05D 2105/15; G05D 2107/21

(57) ABSTRACT

A system and method for executing a work process using a planning system. A planning system comprises a user interface, a communication unit, a computing unit and a memory unit. The planning system is configured to generate a plan for executing an agricultural work process or at least one sub-process included in the work process and transmitting it to an autonomous agricultural work machine configured for the execution for controlling, regulating and/or parameterizing the autonomous work machine and at least one attachment configured to the work machine. The planning system is configured to retrieve and use data saved in at least one database in order to generate the plan for the operation of the autonomous work machine, which data are working-machine-specific, attachment-specific and field-specific parameters, and ambient and environmental parameters available at the time of the generation of the plan, and to output the plan via the user interface.

### CROSS REFERENCE TO RELATED APPLICATIONS

This application claims priority under 35 U.S.C. § 119 to German Patent Application No. DE 10 2024 114 798.9 filed May 27, 2024, the entire disclosure of which is hereby incorporated by reference herein.

### TECHNICAL FIELD

The present invention relates to a system and method for planning an agricultural work process.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

US Patent Application Publication No. 2023/0350407 A1, incorporated by reference herein in its entirety, discloses an assistance system based on data exchange, which may configure an autonomous vehicle suitable for use on an agricultural area which may act as an agricultural work machine, may plan use, may transmit the data required for use to the vehicle, may control the vehicle, and may monitor a working mode. For this purpose, a manually created customer-specific deployment plan is transmitted to the assistance system, which describes the type and scope of a service to be provided by the autonomous vehicle. A customer provides the customer-specific deployment plan for this purpose. The given time of use is specified, such as at least the time period in which the service is to be provided. Furthermore, the customer-specific deployment plan may include the deployment location(s) and the sequence and type of work activities to be performed.

The client may communicate with the assistance system via an external interface or via a platform, through which a customer-specific deployment plan may be configured and transferred to the assistance system.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic and exemplary representation of a planning system.

FIG. 2 illustrates a schematic representation of a user interface of the planning system.

FIG. 3 illustrates a schematic representation of a menu option of the planning system selected via the user interface.

FIG. 4 illustrates a schematic representation of a route generated by the planning system that is output via the user interface.

### DETAILED DESCRIPTION

As discussed in the background, US Patent Application Publication No. 2023/0350407 A1 discloses that the client may communicate with the assistance system, through which the customer-specific deployment plan may be configured and transferred to the assistance system. The configuration of the vehicle acting as an agricultural work machine resulting from the specified customer-specific deployment plan and created by the assistance system and the deployment planning may not be transparent for the customer.

One object of the present application may comprise a planning system through which the pre-planning configuration of autonomous agricultural work machines may be simplified.

In one or some embodiments, a planning system is disclosed that comprises a user interface (e.g., a touchscreen, a user input device and/or output device, or the like), a communication unit (e.g., a wired and/or wireless communication device), a computing unit (e.g., at least one processor, at least one controller, at least one control device, or the like) and a memory unit (e.g., at least one memory, etc.). The planning system is configured generate a plan for performing an agricultural work process or at least one sub-process comprised by the work process and to transmit the plan to at least one autonomous agricultural work machine, with the at least one autonomous agricultural work machine configured to (e.g., automatically) to execute the plan in order to perform any one, any combination, or all of: (i) controlling at least one autonomous agricultural work machine and/or at least one attachment connected or adapted to the at least one autonomous agricultural work machine; (ii) regulating at least one autonomous agricultural work machine and/or the at least one attachment connected or adapted to the at least one autonomous agricultural work machine; or (iii) parameterizing at least one autonomous agricultural work machine and/or the at least one attachment connected or adapted to the at least one autonomous agricultural work machine. In one or some embodiments, the planning system is configured to retrieve or access and use data saved in the at least one memory (e.g., at least one database) to generate the plan for the operation of the autonomous work machine, which data may comprise any one, any combination, or all of working-machine-specific parameter(s); attachment-specific parameter(s); field-specific parameters; ambient and/or environmental parameter(s) (e.g., ambient and/or environmental parameter(s) available or sensed or determined at the point in time when the plan is generated). Further, the generated plan may be automatically output, such as via the user interface, to an operator or the like.

With the planning system, some or all relevant parameters and settings of the autonomous work machine and the attachment adapted thereto may be generated independent of the system and before the planned use of the autonomous work machine. For this purpose, in one or some embodiments, the planning system may be cloud-based and/or locally server-supported.

In one or some embodiments, access to the user interface may be web-based, such as via a web page executable via an Internet browser so that authorization-dependent access to the planning system may occur via one or more networks.

In particular, the planning system may access specific process knowledge that is saved or may be saved in the at least one database in order to improve the process of optimizing the planning. The ability to save process knowledge may enable changes and/or additions.

The autonomous agricultural work machine may, on the one hand, be designed as specialized, as would be the case for example with an autonomous combine harvester or forage harvester, or on the other hand generalized. Generalized may mean that the autonomous agricultural work machine is an autonomous agricultural universal work machine, which may be characterized by changing configurations of the attachments and/or changing software modules for controlling the work machine and/or the adapted attachments in order to be useful for a variety of different agricultural work tasks.

The individual work processes and/or the sub-processes of an agricultural harvesting campaign encompassed thereby may follow one another as required, for example depending on any one, any combination, or all of: the type of harvest material; environmental condition(s); or an objective of a cultivation, processing and/or harvesting process on which the harvesting campaign is based.

In one or some embodiments, the planning system may be configured to take into account and to input, in the generation of the plan (e.g., in order to optimize the plan), process data of an agricultural harvesting campaign to be processed, which may comprise the work process and/or at least one further deviating work process and a resource plan associated with the work processes. This may take into account the fact that the individual work processes of the agricultural harvesting campaign may build on each other in over time and may generally be interdependent.

In one or some embodiments, the time interval between the individual work processes may vary. For example, plowing may accordingly be followed promptly by the use of a harrow or other soil cultivator, which may help to improve the crumbling of the soil before sowing occurs. In contrast, there may be a significantly longer time period between the work process of sowing process and the work process of harvesting, during which the agricultural harvesting campaign is therefore subject to external influences to a greater extent. In between (e.g., between the work process of sowing and the work process of harvesting), the use of fertilizers and/or pesticides may be provided as further work processes of the agricultural harvesting campaign.

In particular, the planning system may be designed to access at least one plan from a planning process in the past (e.g., at least one previous plan) for a previous work process, such as a plan from the previous year, and based on this, to assign the plan on which the corresponding work process was based in the past to the work process to be performed. This may simplify and accelerate the generation of the plan of the work process to be performed by using the planning process from the past as a basis.

In one or some embodiments, the planning system may be designed to take into account, when generating the plan, any one, any combination, or all of: future work processes; past work processes; a route plan generated in a future work process; or a route traveled by an agricultural work machine.

In one or some embodiments, the planning system may be configured to automatically generate a proposal for the plan to be generated for the work process to be performed based on data of the same work process (e.g., the same agricultural work process as to be performed) at the same location (e.g., the same location as the agricultural work process is to be performed) recorded in a past comparative period (e.g., a same time of year) from the past and to make it available for selection by an operator via the user interface (e.g., entering a command via the touchscreen). Responsive to receiving input from the operator selecting the proposal, the planning system may be configured to generate the plan (e.g., responsive to the operator agreeing with the proposal, the planning system may generate the plan based on the proposal; responsive to the operator disagreeing with the proposal, the planning system may generate an alternative plan that is different from the proposal).

In addition or alternatively, the planning system may be configured to automatically generate a proposal for the plan to be generated for the work process to be performed based on comparative data of the same work process at at least one other location and make it available for selection by the operator via the user interface. (e.g., responsive to the operator agreeing with the proposal, the planning system may generate the plan based on the proposal; responsive to the operator disagreeing with the proposal, the planning system may generate an alternative plan that is different from the proposal). This may be advantageous if no data is available for the location in question for which the plan is to be created, for example when working a field for the first time and/or for the use of a different type of crop.

For this purpose, the planning system may be configured to evaluate the comparative data of the same work process performed at several other locations and to form mean values for the given data and/or to determine the comparative data of a location with maximum yield on which the execution of a work process is based and to use the data based on mean values and/or maximum yield to generate the plan. This may allow a planning basis to be created for the planning to be generated, for example when the location is worked for the first time.

The comparative data of the same work process performed at the at least one other location may include, among other things, any one, any combination, or all of: the nature and/or type of utilized autonomous machine and attachment; their plan at the time the work process is performed; crop type; soil conditions; weather conditions; or area data in order to enable comparability of the data.

In one or some embodiments, in order to generate the optimized plan by the planning system, the planning system may be configured to analyze existing comparative data using artificial intelligence (AI). For this purpose, the planning system may use an artificial neural network to evaluate the comparative data collected at one or more locations for a specific harvesting campaign and/or a specific work process, which may represent any one, any combination, or all of: the work machine-specific parameters used in the past; attachment-specific parameters used in the past; the field-specific parameters used in the past; or ambient and/or environmental parameters, as an input data set and to determine the planning based thereon as output data. In particular, a trainable analysis algorithm based on artificial intelligence saved in the computing unit may be used to analyze the comparison data. The trainable analysis algorithm may, for example, be based on a trained artificial network, such as an artificial neural network, a so-called ANN, or a convolutional neural network, a so-called CNN. Other trainable AI architectures are also contemplated as a basis for the analysis algorithm.

In one or some embodiments, the planning system may be configured to generate the planning for the work process to be performed in a dialog-guided manner by manual interaction via the user interface (e.g., entering manual touches on the touchscreen). A sequence of dialog steps to be processed may be specified by the planning system, which may basically build on each other hierarchically. To generate the plan, first the type of work process to be planned and/or a sub-process covered thereby may be queried in a first dialog step. In the subsequent dialog step, a combination of an autonomous work machine and the attachment adapted thereto may be determined. In a subsequent dialog step, any one, any combination, or all of the following may be determined; the position of the field to be worked; data on existing field boundaries; or special features of the field (e.g., known obstacles existing in the field). In a subsequent dialog step, the access external conditions saved in the at least one database for the desired work process and/or sub-process, may be enabled taking into account working or environmental conditions.

Using the output of the generated plan via the user interface, the operator of the planning system may be provided with an overview of the resource consumption and operating time of the autonomous work machine, for example. This may enable the operator to manually adjust the generated plan after planning and, such as actively supported by the planning system, to optimize the generated plan according to his or her own ideas. In this regard, the generated plan may be adjusted or modified.

In one or some embodiments, the planning system may be configured to generate a digital image of the field using or accessing topographical data of a field saved in the at least one database, on which the work process and/or sub-process to be planned for the autonomous work machine is to be performed, and the corresponding field-specific parameters of the field, and from the work machine-specific and attachment-specific parameters saved in at least one database, to generate a digital image of the autonomous agricultural work machine and the at least one attachment adapted to the work machine, in order to simulate the execution of the work process and/or subprocess using a mathematical model saved in the memory unit, and to generate the plan based on the simulation. In this regard, the image generated may include one or more subparts that may include overlays or the like.

Work machine-specific and attachment-specific parameters of the autonomous agricultural work machine and the attachment adapted thereto may be geometric data, operating status data and/or equipment data.

Field-specific parameters may, inter alia, be ground data, such as data on any one, any combination, or all of: ground compaction; ground preparation; crop data (e.g., plant cultivation specifics such as data on weeds, data on disease and data on pest infestation, yield data and/or area data); or agricultural indicators (e.g., data on fertilization, data on irrigation, data on herbicides and data on fungicides, geospatial data and/or weather data, including more long-term climate data).

Furthermore, the planning system may be configured to output the plan generated by the simulation via the user interface, such as visually perceptible, wherein manual changes to the framework conditions on which the simulation is based may be performed subsequently using the user interface (e.g., touching or interacting with the touchscreen), wherein the planning system may be configured to perform the simulation again based on the subsequent changes (e.g., in an iterative process, whereby the updated simulation, based on the previous operator input, may be presented to the operator via the user interface for additional input, so that the iterative process may be perform one or a plurality of times). A visually perceptible output of the plan generated by the simulation may be provided by graphics and/or images of autonomous work machines saved in the database, attachments to be adapted thereto and/or a structured output of the plan. In particular, the user interface may be configured to enter and/or select and/or modify at least one work process to be perform and/or an associated route on which the simulation is based.

In particular, the planning system may be configured to visualize work sequences of the work process and/or the sub-process generated using the simulation and result variables associated therewith via the user interface. Result variables of the simulation may, inter alia, be any one, any combination, or all of: resource consumption; distance traveled; work time; start of work; end of work; or parameters required for driving through headlands. Parameters required for driving through headlands may comprise, inter alia, any one, any combination, or all of; a spatial offset to a georeferenced field boundary; a number of parallel staggered headland sections or headland sequences; or a working width. The simulation may take into account field-specific conditions, such as obstacles or the like, which may influence the result variables.

In one or some embodiments, the planning system may be configured to visualize the generated plan using the user interface before executing the planned work process, such as within a predeterminable time interval before execution. The operator of the planning system may therefore be given the opportunity to check the database and the resulting plan before the autonomous work machine actively implements the planned work process. In particular, the generated plan may be edited or modified by the operator of the planning system via the user interface before the execution of the planned work process. This may be necessary if interim events have occurred that were not known at the time of planning by the planning system and/or data and information thereon were not available. Merely a few examples of this may comprise deviations from forecast weather data and/or an unplanned repair of the autonomous work machine and/or attachment provided for execution.

In one or some embodiments, the planning system may be configured to automatically check whether the data, which was used at the time generating the plan, has been updated in the at least one database and to visualize this update via the user interface. This may give the operator of the planning system the opportunity to modify the generated plan taking into account updated data (e.g., the operator may provide input as to the update to the data, which may then be used to remise the plan). Similarly, an already-executed simulation may be performed again or initiated by the operator, such as automatically, due to the update of any one, any combination, or all of: the work machine-specific parameters; attachment-specific parameters; field-specific parameters; or the updated environmental and/or ambient parameters.

In particular, the planning system may be configured to plan at least one harvesting campaign on the basis of data that are saved in a computer with farm management software as a data source, and/or the data source is a computer with agricultural job management software.

In one or some embodiments, the planning system may be configured to select, via the user interface, an individual work process to be performed within the at least one planned harvesting campaign and/or to select a sub-process associated with the selected work process. The planning system may enable the operator to create and simulate the given plan by the planning system down to sub-process level.

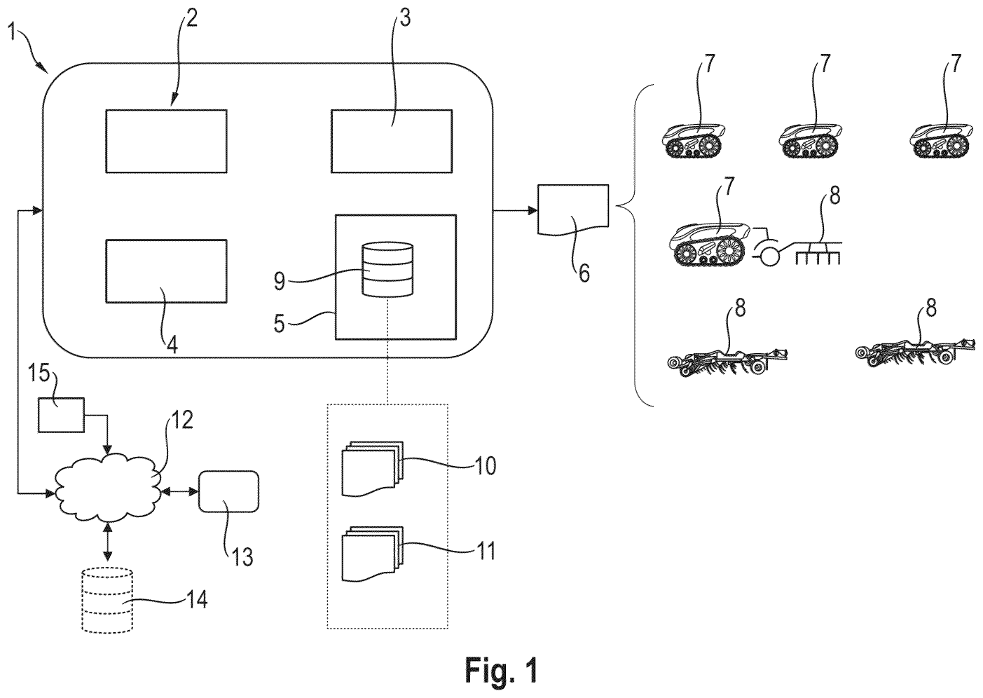

Referring to the figures, FIG. 1 shows a schematic representation of a planning system 1 according. The planning system 1 may comprise a user interface 2 (e.g., a touchscreen, or an input/output device), a communication unit 3 (e.g., a wired and/or wireless communication device (such as a cellular communication network) which may be configured to communicate to another electronic device, such as to a device sitting on the Internet, a wireless device, or the like), a computing unit 4 and a memory unit 5.

The computing unit 4 may comprise at least one processor, such as microprocessor, controller, PLA, or the like. The memory unit 5 may comprise any type of storage device (e.g., any type of memory, such as RAM. ROM, etc. or various forms of memories, such as a database, or the like). Though the computing unit 4 and the memory unit 5 are depicted as separate elements, they may be part of a single machine, which includes a microprocessor (or other type of controller) and a memory. Alternatively, the computing unit 4 may rely on the memory unit 5 for all of its memory needs. Still alternatively, the computing unit 4 may rely on a database for some or all of its memory needs. In this regard, in one or some embodiments, the memory unit 5 may be configured to store data, such as the data as discussed herein. Alternatively, or in addition, the memory unit 5 may comprise a tangible computer-readable medium that include software that, when executed by the computing unit 4 is configured to perform any one, any combination, or all of the functionality described herein, such as the automatic planning and/or updating of the plan 6.

The computing unit 4 is merely one example of a computational configuration for the electronic devices discussed herein. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC). Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The planning system 1 is configured to generate a plan 6 for execution of an agricultural work process or at least one sub-process included in the work process in advance of the time of execution. The planning system 1 may further be configured to transmit (e.g., wired and/or wirelessly) the plan 6 via the communication unit 3 to an autonomous agricultural work machine 7 designed for the execution for controlling, regulating and/or parameterizing the autonomous work machine 7 and at least one attachment 8 adapted to the work machine 7. Furthermore, the planning system 1, via the communication unit 3, may receive data and information that are generated by the autonomous agricultural work machine 7 and/or the attachment 8 during the execution of the planned agricultural work process or the at least one sub-process. In this regard, the planning system 1 may, responsive to and triggered by receipt of data and information that are generated by the autonomous agricultural work machine 7 and/or the attachment 8 during the execution of the planned agricultural work process or the at least one sub-process, may update the plan 6.

The planning system 1 may be configured to automatically retrieve and automatically use data stored in at least one database 9 to automatically generate the plan 6 for the operation of the autonomous work machine 7, which data may be working-machine-specific, attachment-specific and field-specific parameters 10 (any discussion regarding working-machine-specific, attachment-specific and field-specific parameters 10 may comprise any one, any combination, or all of: working-machine-specific parameters; attachment-specific parameters; or field-specific parameters) and/or ambient and environmental parameters 11 available at the point in time of the generation of the plan 6. The plan 6 generated on this basis may be output via the user interface 2.

Access to the user interface 2 may be web-based, such as via a web page 13 that may be executed using an Internet browser so that authorization-dependent access to the planning system 1 may occur via a network 12.

The planning system 1 may automatically access at least one external data source 14 via the network 12. The external data source 14 may also be a database and/or a farm management system 15, in which work machine-specific, attachment-specific and field-specific parameters 10 and/or ambient and environmental parameters 11 are saved or may be saved.

For example, the planning system 1 may depict one or more harvesting campaigns on the basis of information and data saved in the at least one database 9 and/or in the farm management system 15, which may be automatically retrieved by the planning system 1. The information and data include, for example, information on fields that may be worked, autonomous work machines 7 contained in the agricultural vehicle fleet and attachments 8 that may be adapted thereto, as well as their given availability. The individual work processes and/or the sub-processes of an agricultural harvesting campaign encompassed thereby may follow one another as required, for example depending on the type of harvest material, environmental conditions and/or an objective of a cultivation, processing and/or harvesting process on which the harvesting campaign is based.

Using the user interface 2, a user of the planning system 1 may select a harvesting campaign and/or an individual work process and/or a sub-process of a work process in order to plan it. For example, a selectable harvesting campaign may include all work processes comprising the cultivation and harvesting of grain. In a subsequent step, the operator may select an associated work process, for example the work process of ground cultivation or crop protection. The work process of ground cultivation may, in turn, be subdivided into several sub-processes. The planning system 1 may generate the plan 6 on the basis of the user-specific selection of the work process and/or the sub-process.

When generating the plan 6, the planning system 1 may be configured to take into account process data of an agricultural harvesting campaign to be worked, which may include the work process and/or at least one other deviating work process and a resource planning associated with the work processes, as input variables for optimizing the plan 6. Examples may comprise the work processes of tillage and sowing preceding work process of crop protection. Downstream work processes are, for example, fertilization or mechanical control of weeds in the crop. The resource planning may take into account the required and suitable work machine 7 and the attachment 8 in the context of the given work process, their required operating resources and the like.

The planning system 1 may be configured to automatically access at least one planning process of a plan from the past, in particular a previous year's planning, and, based on this, to automatically assign the planning of the historical planning process to the work process to be performed, which was already the basis for the corresponding work process in the past. The plan created in the past may form a basis for the plan 6 for the work process to be performed, which may be modified by the planning system 1 in accordance with the work machine-specific, attachment-specific and field-specific parameters 10 and/or ambient and environmental parameters 11 available at the time of the generation of the plan 6. This accordingly may apply to the sub-processes included by the work process.

In the generation of the plan 6, the planning system 1 may therefore be designed to take into account work processes before and/or after the work process to be executed and/or a route plan generated in a previous work process and/or a route already traveled by an agricultural, manned and/or unmanned, work machine 7. The route plan generated in a work process before the work process to be planned may have been recorded by a manned work machine and/or an autonomous work machine 7. For example, already generated or existing lanes may be used in a previous work process, such as sowing, in order to take their position into account in the work process of plant protection to be planned by the executing work machine 7 and the attachment 8 adapted thereto. The above example may be understood as merely an example; an analogous application is contemplated, for example, in a harvesting campaign, which may have as its object the production of feed.

According to a further aspect, the planning system 1 may be configured to automatically generate a proposal for the plan 6 to be generated for the work process to be performed based on data from the same work process at the same location recorded in a comparative period from the past, such as the previous year or such as a same previous season, a same previous month, and make it available to the operator for selection by means of the user interface 2. This may yield a simplification of the generation of plan 6. The recording and/or provision of comparative data, which arose in a comparative period from the past (e.g., a same time of year, a same month, a same week, etc.), may be performed by a manned and/or autonomous work machine 7 and/or by manual input by the operator. The comparative data may be retrievably saved both in the at least one database 9 of the planning system 1 as well as in the external data source 14, in particular the farm management system 15.

A further possibility arises from the fact that the planning system 1 is configured to automatically generate a proposal for the plan 6 to be generated for the work process to be performed based on comparative data of the same work process at at least one other location, and to make it available for selection via the user interface 2. This may enable the operator, in the absence of comparative data for the specific field to be worked, to receive at least one proposal for the plan 6 to be generated, or to compare this proposal with the comparative data for the comparative period from in the past for the relevant field.

According to a further aspect, the planning system 1 may be configured to evaluate the comparative data of the same work process performed at several other locations and to form mean values for the given data and/or to determine the comparative data of a location with maximum yield on which the execution of a work process is based and to use the data based on mean values and/or maximum yield to generate the plan 6.

A further possibility for generating the optimized plan 6 by the planning system 6 comprises (or consists of) the planning system 1 analyzing existing comparative data using artificial intelligence (AI). For example, the planning system 1 may use an artificial neural network to evaluate the comparative data, which may represent the work machine-specific, attachment-specific and field-specific parameters 10 and/or ambient and environmental parameters 11 used in the past, as an input data set and to automatically determine the plan 6 based thereon as output data.

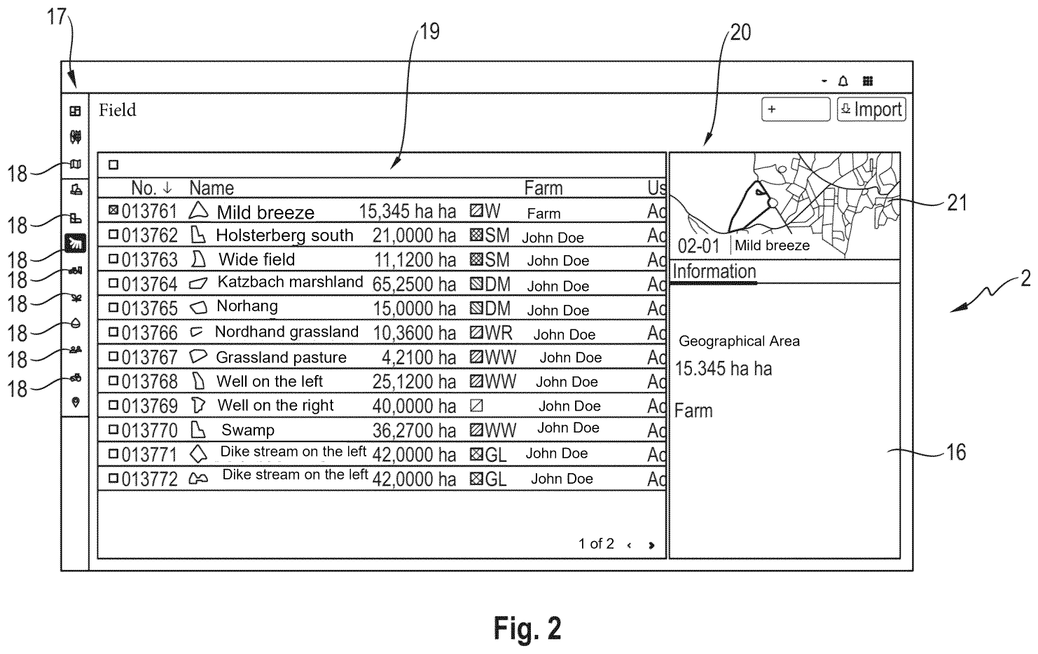

In one or some embodiments, the planning system 1 may be configured to execute the generation of the plan 6 for the work process to be performed dialog-guided using manual interaction via the user interface 2. This process is explained in more detail below with reference to FIGS. 2 to 4.

A further aspect may comprise (or consist of) the simulation of the work process to be executed by an autonomous agricultural work machine 7 suitable for the execution and the at least one attachment 8 adapted to the work machine 7. The planning system 1 is configured, using topographical data, saved in the at least one database 9, of the field on which the work process to be planned for the autonomous work machine 7 is to be performed, and the corresponding field-specific parameters 10 of the field, to generate a digital image of the field, and of the autonomous agricultural work machine 7 and the at least one attachment 8 adapted to the work machine 7 from the work machine-specific and attachment-specific parameters 10 saved in the at least one database 9, in order to simulate the execution taking into account the ambient and environmental parameters 11 using a mathematical model saved in the memory unit 5, and to automatically generate the plan 6 on the basis of the simulation.

In one or some embodiments, the planning system 1 is configured to output, such as visually output, the plan 6 generated by the simulation via the user interface 2. Using the user interface 2, subsequent manual changes by the operator may be made to the framework conditions on which the simulation is based.

The planning system 1 may furthermore be configured to again execute the simulation based on the subsequent changes in order to adapt or updated the generated plan 6 to subsequently-changed framework conditions. Depending on the time interval between the planning and the provided execution of the work process, changes to the framework conditions may be due to events that are short-term or lying further in the past. An event further in the past may be, for example, a dry period or a rainy period in spring that was not taken into account at the time of planning. Example events occurring on short notice may be a cold snap or a breakdown of scheduled work machines 7 and/or front attachments 8. Similarly, the occurrence of a rainy phase between two already-planned, consecutive work processes may lead to the simulation having to be executed again under different framework conditions. This may be performed automatically by the planning system 1 depending on the occasion (e.g., responsive to and triggered by receiving the updated data regarding short-term or longer-term events, the planning system 1 may be configured to automatically update the plan 6 and/or perform a new simulation). Alternatively, the operator of the planning system 1 may initiate the new simulation manually.

The planning system 1 may be configured to visualize, via the user interface 2, work sequences of the work process generated by the simulation and associated result variables, such as any one, any combination, or all of: resource consumption; traveled routes; work time; start of work; end of work; duration of use of the autonomous work machine; and the like.

In one or some embodiments, the planning system 1 may be configured to visualize the generated plan 6 via the user interface 2 before executing the planned work process, such as within a predeterminable time interval before execution. This may be based on the consideration that the time of executed plans of a work process and the resulting plan 6 may be significantly different. For example, there may be time spans that may include several days, weeks or months between the individual work processes, but also between individual sub-processes. Accordingly, the visualization via the user interface 2 may offer the operator the opportunity to check and, if necessary, adjust the already-generated plan 6 within a predeterminable time interval before the execution of the planned work process and/or sub-process.

For example, the planning system 1 may be configured to automatically check whether the data that was used at the time of the generation of the plan 6 has been updated in the at least one database 9, and to automatically indicate that updating of the data (e.g., using a visualization via the user interface 2). This may enable the operator of the planning system 1 to be notified of the updating of the data and/or to have a simulation, which was generated further back in time, be performed again by the planning system 1.

FIG. 2 illustrates a schematic representation of the user interface 2 of the planning system 1. With the planning system 1, some or all relevant parameters and settings may be generated by the system of the autonomous work machine 7 and the attachment 8 adapted thereto independently and before the planned use of the autonomous work machine 7 or the combination.

The user interface 2 may comprise a user interface 16 (e.g., a graphical user interface, such as a touchscreen), which may serve to input and/or select as well as output information. Various icons 18, which may comprise different menu options, may be arranged in a column 17 of the user interface 16. In the illustrated embodiment, the icon 18 with the selected menu option “Fields” is highlighted. In a section 19 arranged next to column 17, an overview of various agricultural usable areas, such as fields and parcels, with specific parameters, such as designation and geographical area, is shown. These specific parameters may be retrieved from the at least one database 9 of the planning system 1. The parameters for the individual agricultural usable areas depicted in the overview in section 19 are taken from the at least one database 9. As an example, a specific agricultural usable area selected from the overview in section 19 is graphically displayed in a further section 20 of the user interface 16. In addition to a miniature map 21, which shows, for example, an aerial view of a section of the landscape in which the selected agricultural usable area is located, additional parameters may be depicted which, in addition to the geographical area, also show the type of farm cultivating the agricultural usable area, the first cultivation of the usable area as well as the current status of the agricultural usable area, i.e. active, e.g. use for the cultivation of plants or other use in an agricultural context, or passive, for set-aside or fallow usable areas.

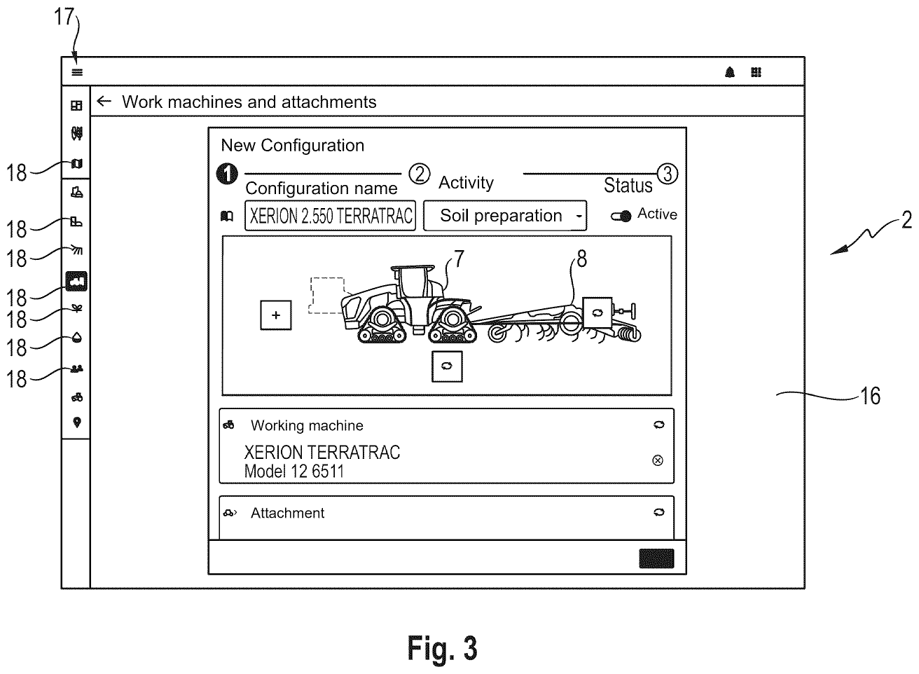

FIG. 3 illustrates a schematic representation of a menu option of the planning system 1 selected via the user interface 2. The actively selected icon 18, here the menu option “Work machines and attachments”, is depicted as highlighted. In this case, a new combination of an autonomous agricultural work machine 7 and an attachment 8 may be configured for the previously-selected working area for a specific agricultural work process to be performed, in this case for example the soil cultivation activity as a work process.

The selection by the operator may be limited to the suitable autonomous work machines 7 and the attachments 8 suitable for the work process to be performed, which may be considered available at the time of the generation of the plan 6.

Alternatively, as explained above, a combination of an autonomous agricultural work machine 7 and an adapted attachment 8 already saved in the database 9 may be accessed.

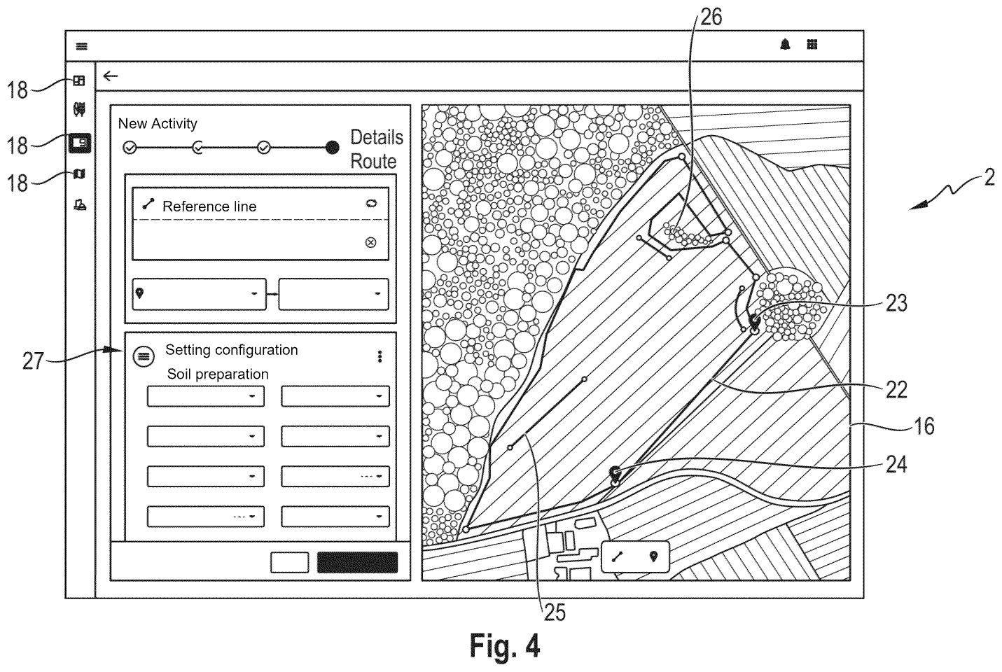

FIG. 4 illustrates a schematic representation of a route generated by the planning system 1 as a part of the plan 6 that is output by means of the user interface 2.

For this purpose, the planning system 1 may output work machine-specific, attachment-specific and field-specific parameters 10 for the soil cultivation work process as part of the plan 6. This may be the representation of a field boundary 22 of a field to be worked selected in the previous step, as explained with reference to FIG. 2, information on a starting point 23 and an end point 24 for deriving at least one reference line 25. Further parameters may be a field contour specified by the field boundary 22 and/or obstacles 26 present in the field. The plan 6 illustrated in FIG. 4 limited to route planning may be based on data saved in the database 9 for this specific field, as already explained above.

Furthermore parameters 6 for planning required for route planning may be displayed in a display segment 27, for example any one, any combination, or all of: a distance to be maintained from the field boundary 22; a working width of the attachment 8; a track width of the work machine 7; or a number of headland sequences. These parameters may be changed by the operator.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Planning system
2 User interface
3 Communication unit
4 Computing unit
5 Memory unit
6 Planning
7 Autonomous work machine
8 Attachment
9 Database
10 Parameter
11 Parameter
12 Network
13 Website
14 Data source
15 Farm management system
16 User interface
17 Column
18 Icon
19 Section
20) Section
21 Miniature map
22 Field boundary
23 Start point
24 End point
25 Reference line
26 Obstacle
27 Display segment

1. A planning system comprising:
a user interface;
a communication unit;
at least one memory; and
at least one processor in communication with the user interface, the communication unit, and the
at least one memory, the at least one processor configured to:
generate a plan for executing an agricultural work process or at least one sub-process included in the agricultural work process by:
accessing data saved in the at least one memory, wherein the data comprises one or more working-machine-specific parameters, one or more attachment-specific parameters, one or more field-specific parameters, one or more ambient and environmental parameters available at a time to generate the plan; and
generating, using the data, the plan for operation of at least one autonomous agricultural work machine;
output, via the user interface, the plan; and
transmit, via the communication unit, to the at least one autonomous agricultural work machine in order to perform one or more of controlling, regulating or parameterizing of one or both of the at least one autonomous agricultural work machine or at least one attachment adapted to the at least one autonomous agricultural work machine.

2. The planning system of claim 1, wherein the planning system is configured to input, in generating the plan, process data of an agricultural harvesting campaign to be processed; and
wherein the process data comprises the agricultural work process, at least one further deviating work process, and a resource plan associated with the agricultural work process, with each being input to the planning system in order for the planning system to optimize the plan.

3. The planning system of claim 1, wherein the planning system is configured to:
access at least one previous plan of a planning process generated previously for a previous work process; and
generate, using the at least one previous plan, the plan.

4. The planning system of claim 3, wherein, in generating the plan, the planning system is configured to take into account the work processes both before and after the agricultural work process to be executed.

5. The planning system of claim 4, wherein, in generating the plan, the planning system is further configured to take into account a route plan generated in the previous work process.

6. The planning system of claim 5, wherein, in generating the plan, the planning system is further configured to take into account a route already traveled by the agricultural work machine.

7. The planning system of claim 1, wherein the planning system is configured to:
automatically generate a proposal for the plan based on data from a same agricultural work process at a same location recorded in a past comparative period; and
automatically output, via the user interface, the proposal for selection by an operator.

8. The planning system of claim 1, wherein the planning system is configured to:
automatically generate a proposal for the plan based on comparative data of a same agricultural work process at at least one other location; and
automatically output, via the user interface, the proposal for selection by an operator.

9. The planning system of claim 8, wherein the planning system is configured to:
determine the comparative data of a location with maximum yield on which the execution of the same agricultural work process is based; and
use the comparative data of the location with the maximum yield to generate the plan.

10. The planning system of claim 9, wherein the planning system is further configured to:
evaluate the comparative data of the same agricultural work process performed at a plurality of other locations;
form mean values for the comparative data of the same agricultural work process performed at a plurality of other locations; and
use the comparative data of both the location with the maximum yield and the mean values to generate the plan.

11. The planning system of claim 1, wherein the planning system is configured to generate the plan for the agricultural work process using dialog-guided manual interaction with an operator via the user interface.

12. The planning system of claim 1, wherein the planning system is configured to:
access topographical data that is saved in the at least one memory, the topographical data of a field on which the agricultural work process to be planned for the autonomous agricultural work machine is to be performed;
generate an image indicative of a simulation of the plan using the topographical data and of the autonomous agricultural work machine and of the at least one attachment adapted to the autonomous agricultural work machine using corresponding field-specific parameters of the field and, from the one or more working-machine-specific parameters and the one or more attachment-specific parameters;
output the image in order to solicit input from an operator; and
responsive to the input from the operator, generate the plan.

13. The planning system of claim 12, wherein the planning system is configured to generate the simulation of the plan using a mathematical model, and to generate the plan based on the simulation;
wherein the simulation is based on one or more framework conditions;
wherein the input from the operator comprises one or more manual changes to the one or more framework conditions; and
wherein the planning system is configured to perform the simulation again based on the one or more manual changes to the one or more framework conditions.

14. The planning system of claim 13, wherein the planning system is configured to visualize, via the user interface, work sequences of the agricultural work process generated via the simulation and result variables associated therewith.

15. The planning system of claim 1, wherein the planning system is configured to:
visualize, via the user interface, the plan before executing the agricultural work process no earlier than a predeterminable time interval before execution of the agricultural work process;
output, via the user interface, the visualization of the plan;
receive input regarding the visualization of the plan; and
revise, based on the input, the plan.

16. The planning system of claim 1, wherein the planning system is further configured to:
automatically check whether the data used to generate the plan has been updated;
visualize, via the user interface to an operator, the updating of the data;
receiving input from an operator regarding the updating of the data; and
revise the plan based on the input.

17. The planning system of claim 1, wherein the planning system is configured to access the data from one or both of farm management software or agricultural job management software.

18. The planning system of claim 1, wherein the planning system is further configured to:
receive one or more selections, via the user interface, of an individual work process to be executed within one or both of at least one planned harvesting campaign or of a sub-process associated with the individual work process; and
wherein the planning system is configured to generate the plan based on the one or more selections.
